(19) United States
(12) Patent Application Publication
(10) Pub. No.: US 2011/0125963 A1
(43) Pub. Date: May 26, 2011

(54) ELECTRONIC DEVICE WITH DATA BACKUP/RESTORE CAPABILITY

(76) Inventor: Zhi-Ming Sun, Hsinchu City (TW)

(21) Appl. No.: 12/764,947

(22) Filed: Apr. 22, 2010

(30) Foreign Application Priority Data
Nov. 24, 2009 (TW) 098139980

(51) Int. Cl. G06F 12/16

(52) U.S. Cl. 711/114; 711/162; 711/E12.103; 710/306

(57) ABSTRACT

An electronic device with data backup/restore capability includes a connection port, an internal storage device, a storage device controller, a processor and a bridge circuit. The internal storage device is used for storing data. The storage device controller is coupled to the connection port and the internal storage device, for controlling data accessing and data backup/restore operations of the internal storage device. The processor is used for controlling the operation of the electronic device. The bridge circuit is coupled between the storage device controller and the processor.

### BACKGROUND OF THE INVENTION

1. Field of the Invention

The present invention relates to an electronic device with data backup/restore capability, and more particularly, to an electronic device which can backup/restore data of a mobile device automatically.

2. Description of the Prior Art

In modern society, computer systems, such as desktops, notebook computers, servers and so on, are becoming part of everyday life. Document processing is almost exclusively dealt with via computer systems. A notebook (NB) has several advantages over a desktop computer, including its small-sized volume, light weight, and portability. These properties give a user the flexibility to work in any location. A small, thin, and light NB provides the user with powerful computation and document processing abilities and complete multimedia functions anywhere and anytime. Heavy and large-sized desktop computers do not offer this capability to their users. When unstable situations occur in the computer system (e.g. NB), however, if the whole computer system or parts of the device implemented in the computer system are broken, the user's personal data cannot be restored and the personal data stored in the computer system may be lost completely.

Therefore, the concepts of data backup/restore are widely known, by which a user can backup important data or files in an external target device. If the data inside the computer system are damaged, the user can utilize the backup data inside the target device to restore the damaged data. For example, the user can directly copy data into the target device, or execute a backup program to burn data/files into an image file and store the image file in the target device.

Prior art methods utilize some kinds of data backup software to back up the data stored in the personal computer into an internal storage device or an external storage device at regular intervals, or according to a user's requirement. According to the prior art, however, the user still needs to manually select which data will be backed up, back up the selected data, and upload the selected data, which requires considerable time and effort. In addition, if a situation occurs in which the mobile electronic device is lost and the user has not backed up the personal data, it will cause the user substantial difficulties. Furthermore, as some users are not familiar with the installing and setting operations of the data backup software, it is difficult for them to set the data backup software themselves, resulting in some operational errors. In other words, today's backup/restore programs do not enable the users to complete backup/restore operations easily.

### SUMMARY OF THE INVENTION

It is therefore one of the objectives of the present invention to provide an electronic device with data backup/restore capability, which can perform backup/restore operations automatically to solve the above mentioned problems.

According to an embodiment of the present invention, an electronic device with data backup capability is disclosed. The electronic device includes a connection port, an internal storage device, a storage device controller, a processor and a bridge circuit. The internal storage device is used for storing data. The storage device controller is coupled to the connection port and the internal storage device, and implemented for controlling data accessing and data backup operations of the internal storage device. The processor is used for controlling the operation of the electronic device. The bridge circuit is coupled between the storage device controller and the processor.

According to another embodiment of the present invention, an electronic device with data restore capability is disclosed. The electronic device includes a connection port, an internal storage device, a storage device controller, a processor and a bridge circuit. The internal storage device is used for storing data. The storage device controller is coupled to the connection port and the internal storage device, and implemented for controlling data accessing and data restore operations of the internal storage device. The processor is used for controlling the operation of the electronic device. The bridge circuit is coupled between the storage device controller and the processor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device with data backup/restore capability according to an exemplary embodiment of the present invention.

FIG. 2 is a state diagram illustrating operational states of the electronic device shown in FIG. 1.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

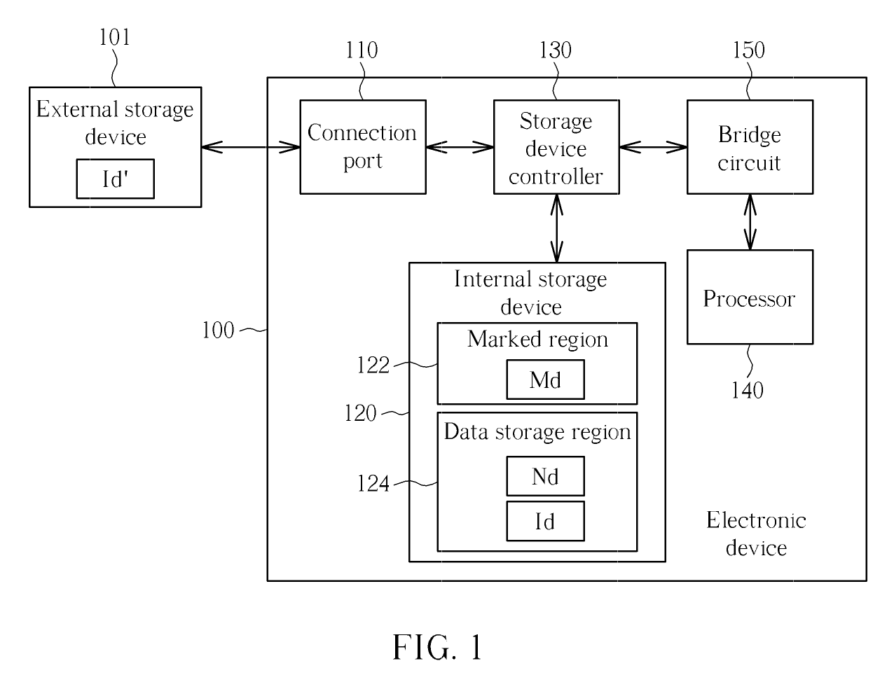

Please refer to FIG. 1. FIG. 1 is a diagram illustrating an electronic device 100 with data backup/restore capability according to an exemplary embodiment of the present invention. The electronic device 100 includes, but is not limited to, a connection port 110, an internal storage device 120, a storage device controller 130, a processor 140 and a bridge circuit 150. The connection port 110 is used for connecting the electronic device 100 to an external storage device 101. For example, the electronic device 100 may be a portable device (i.e. a mobile device), and the external storage device 101 may be an external hard disk drive (HDD), which electrically connects to the electronic device 100 via a connection port (e.g., a USB connection port) of the portable device. Please note that this modification is only regarded as an example and not a limitation of the present invention. The internal storage device 120 is for storing data and includes a marked region 122 and a data storage region 124. The marked region 122 is used for storing each of the marked data MD generated by the storage device controller 130. The data storage region 124 is used for storing normal data Nd and identification data Id, where the normal data Nd are data not classified as marked data. The storage device controller 130 is coupled to the connection port 110 and the internal storage device 120, for controlling data accessing and data backup/restore operations of the internal storage device 120. Please note that, in this exemplary embodiment, the storage device controller 130 may be implemented by a redundant array of independent disks (RAID) on chip controller; however, this is for illustrative purposes only, and is by no means to serve as a limitation to the scope of the present invention. Using other circuits or devices that support the same function also falls within the scope of the present invention. The processor 140 is used for controlling the operation of the electronic device 100. The bridge circuit 150 is coupled between the storage device controller 130 and the processor 140. For example, the bridge circuit 150 may be a south bridge circuit.

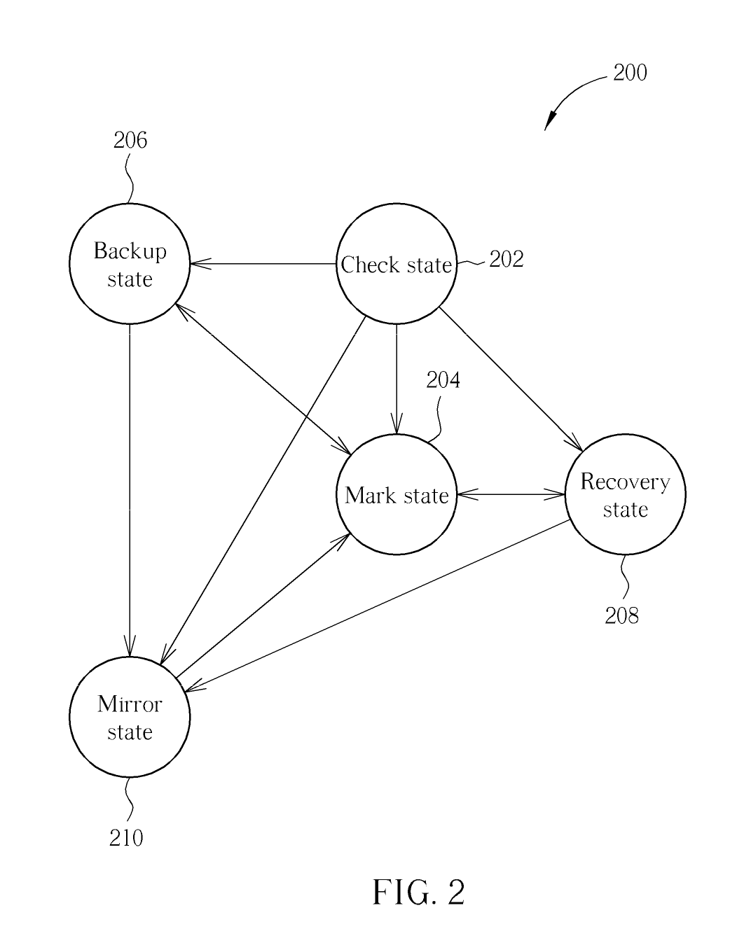

Please refer to FIG. 2 in conjunction with FIG. 1. FIG. 2 is a state diagram illustrating operational states of the electronic device 100. The state diagram shows five different states, including a check state 202, a mark state 204, a backup state 206, a recovery state 208 and a mirror state 210. Please note that, in order to describe the spirit of the state diagram of the electronic device 100 more clearly, the description related to FIG. 2 is illustrated by the related operations between the electronic device 100 and the external storage device 101.

At first, the electronic device 100 will enter the check state 202. When the electronic device 100 operates in the check state 202, the storage device controller 130 detects if the external storage device 101 is connected to the electronic device 100 via the connection port 110. When the storage device controller 130 does not detect that the external storage device 101 is connected to the electronic device 100, the electronic device 100 enters the mark state 204. In the mark state 204, if the data stored in the internal storage device 120 are changed, the storage device controller 130 generates corresponding marked data Md to mark each changed data and stores the marked data Md into the internal storage device 120. When the storage device controller 130 detects that the external storage device 101 is connected to the electronic device 100 and the internal storage device 120 has at least a marked data Md, the electronic device 100 enters the backup state 206. In the backup state 206, the storage device controller 130 performs an updating operation to update the external storage device 101 according to the marked data Md. When the updating operation is finished, the storage device controller 130 deletes the marked data Md, and then enters the mirror state 210. In the mirror state 210, if the data stored in the internal storage device 120 are changed, the storage device controller 130 will update the data stored in the external storage device 101 according to each changed data stored in the internal storage device 120.

When the storage device controller 130 detects that the external storage device 101 is connected to the electronic device 100 and the internal storage device 120 does not have any marked data Md, the electronic device 100 enters the mirror state 210; when the storage device controller 130 detects that the external storage device 101 is connected to the electronic device 100 and the identification data Id stored in the internal storage device 120 and an identification data Id′ stored in the external storage device 101 do not fit into a predetermined corresponding relation, the electronic device 100 enters the recovery state 208. In the recovery state 208, the storage device controller 130 performs a data restore operation upon the internal storage device 120 to write the data stored in the external storage device 101 back into the internal storage device 120, and the electronic device 100 enters the mirror state 210 when the data recovery operation is finished. Furthermore, no matter whether the electronic device 100 is in the backup state 206, the recovery state 208, or the mirror state 210, if the connection between the electronic device 100 and the external storage device 101 breaks off, the electronic device 100 will enter the mark state 204.

In summary, the storage device controller 130 of the electronic device 100 will automatically perform data backup/restore operations upon the internal storage device 120 according to the marked data Md and the identification data Id; therefore, the electronic device 100 can back up/restore all of the data stored in the internal storage device 120 without a user's intervention. In addition, when the data stored in the internal storage device 120 of the electronic device 100 are lost or damaged, the processor 140 can utilize the external storage device 101 directly via the bridge circuit 150 and the storage device controller 130. At the same time, the storage device controller 130 restores the internal storage device 120 with the data stored in the external storage device 101, thereby allowing the electronic device 100 to operate normally.

Please note that the description of how the storage device controller 130 performs data backup/restore operations upon the internal storage device 120 automatically is only one preferred embodiment of the present invention. Any electronic device which utilizes the circuit structure shown in FIG. 1 to achieve the backup/restore capability should also fall within the scope of the present invention. Specifically, any electronic device which includes a connection port, an internal storage device used for storing data, a storage device controller coupled to the connection port and the internal storage device, for controlling data accessing and data backup/restore operations of the internal storage device, a processor used for controlling the operation of the electronic device and a bridge circuit coupled between the storage device controller and the processor to achieve the backup/restore capability should fall within the scope of the present invention.

Those skilled in the art will readily observe that numerous modifications and alterations of the device and method may be made while retaining the teachings of the invention.

What is claimed is:

1. An electronic device with data backup capability, comprising:
a connection port;
an internal storage device, for storing data;
a storage device controller, coupled to the connection port and the internal storage device, for controlling data accessing and data backup operations of the internal storage device;
a processor, for controlling an operation of the electronic device; and
a bridge circuit, coupled between the storage device controller and the processor.

2. The electronic device of claim 1, wherein the storage device controller further detects if an external storage device is connected to the electronic device via the connection port; when the storage device controller does not detect that the external storage device is connected to the electronic device, the storage device controller generates corresponding marked data to mark each changed data of the internal storage device; and when the storage device controller detects that the external storage device is connected to the electronic device, the storage device controller determines whether to perform a data backup operation upon the internal storage device to update the external storage device according to the data stored in the internal storage device in accordance with whether the marked data exist or not.

3. The electronic device of claim 2, wherein the internal storage device comprises:
a marked region, for storing each marked data generated by the storage device controller; and
a data storage region, for storing normal data which are data not classified as marked data.

4. The electronic device of claim 2, wherein when the storage device controller detects that the external storage device is connected to the electronic device and the internal storage device has at least a specific changed data marked by a specific marked data, the storage device controller updates the external storage device according to the specific changed data and deletes the specific marked data.

5. The electronic device of claim 2, wherein when the storage device controller detects that the external storage device is connected to the electronic device, the storage device controller further updates the data stored in the external storage device according to each changed data of the internal storage device.

6. The electronic device of claim 1, wherein the storage device controller is a redundant array of independent disks (RAID) on chip controller.

7. The electronic device of claim 1, being a mobile device.

8. The electronic device of claim 1, wherein the storage device controller performs a data backup operation upon the internal storage device automatically.

9. An electronic device with data restore capability, comprising:
a connection port;
an internal storage device, for storing data;
a storage device controller, coupled to the connection port and the internal storage device, for controlling data accessing and data restore operations of the internal storage device;
a processor, for controlling an operation of the electronic device; and
a bridge circuit, coupled between the storage device controller and the processor.

10. The electronic device of claim 9, wherein when the storage device controller detects that an external storage device is connected to the electronic device, the storage device controller determines whether to perform a data restore operation upon the internal storage device to write data stored in the external storage device back into the internal storage device.

11. The electronic device of claim 10, wherein the internal storage device has an identification data, and when the storage device controller detects that the external storage device is connected to the electronic device and the identification data stored in the internal storage device and an identification data stored in the external storage device do not fit into a predetermined corresponding relation, the storage device controller performs the data restore operation upon the internal storage device to write the data stored in the external storage device back into the internal storage device.

12. The electronic device of claim 10, wherein when the storage device controller detects that the external storage device is connected to the electronic device, the storage device controller further updates the data stored in the external storage device according to each changed data of the internal storage device.

13. The electronic device of claim 9, wherein the storage device controller is a redundant array of independent disks on chip controller.

14. The electronic device of claim 9, being a mobile device.

15. The electronic device of claim 9, wherein the storage device controller performs a data restore operation upon the internal storage device automatically.
